(19) United States
(12) Patent Application Publication
(10) Pub. No.: US 2025/0349476 A1
(43) Pub. Date: Nov. 13, 2025

(54) ACTUATORS FOR PARALLEL, LINEAR MOVEMENT WITH SHORT OR LONG TRAVEL

(71) Applicant: Methode Electronics Malta Ltd., Birkirkara (MT)

(72) Inventors: Michael Geppert, Bingen (DE); Elie Assy, Mainz (DE)

(21) Appl. No.: 18/658,576

(22) Filed: May 8, 2024

(51) Int. Cl. H01H 13/14; H01H 13/36; H01H 13/50

(52) U.S. Cl. CPC H01H 13/14; H01H 13/36; H01H 13/50

(57) ABSTRACT

An actuator mechanism may include a first wing including a first pair of actuator pins and a first pair of housing pins, a second wing including a second pair of actuator pins and a second pair of housing pins, and a torsion element. The torsion element mechanically links the first wing with the second wing. A keycap may be pivotably coupled to the first pair of actuator pins and to the second pair of actuator pins, and a housing member may be pivotably coupled to the first pair of housing pins and to the second pair of housing pins. In response to an actuator force applied onto the keycap, the first wing and the second wing act in cooperation with the torsion element to enable parallel movement of the first wing and the second wing to actuate an electrical contact.

### FIELD

The present disclosure relates to the field of electrical actuators, including but not limited to actuator assemblies for parallel, linear movement, such as user interface buttons.

### BACKGROUND

Electronic devices commonly utilize depressible buttons for receiving user input. The button may be, for example, located on a keyboard having several rows of depressible buttons. The button may have markings on a top surface indicating the function of the button. Depressing the button causes the electronic device to perform some corresponding action.

These buttons include a mechanism located beneath a top surface of the depressible button. The mechanism is configured to translate a downward force applied onto the top of the button into movement, thereby triggering an electrical contact or actuator. Once the downward force is released, the mechanism typically returns the button to its original state or to another intermediate state such as, for example, to provide a visual indication that the button is depressed.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view of a button assembly.

FIG. 2 is a partial exploded view of the button assembly of FIG. 1.

FIG. 3 is a top view of a portion of the button assembly of FIG. 1.

FIG. 4 is a perspective view of an actuator assembly.

FIG. 5 is a top view of the actuator assembly.

FIG. 6 is an exposed side view of the system.

FIG. 7A is a first side view of the actuator assembly.

FIG. 7B is a second side view of the actuator assembly.

### DETAILED DESCRIPTION

Various embodiments of the present disclosure relate to systems, devices, assemblies, and apparatuses for a button assembly configured to activate electronic circuitry of the button assembly such as, for example, an electronic switch, in response to pressing a keypad button. In some embodiments, the button assembly may be referred to as an actuator assembly. In some embodiments, pressing the keypad button can include depressing the keypad button. The button assembly is configured to, in response to a downward actuator force applied to the keypad button, translate the downward keypad button travel into pivotal displacement of the actuator assembly, thereby causing one or more portions of the actuator assembly to activate or trigger the electronic circuitry. The button assembly is also configured to compensate for off-center engagement of the keypad button such that these off-center attempts can still result in consistent activation of the electronic circuitry of the keypad button.

According to some embodiments, the button assembly may be a class A part. In this regard, the button assembly including, but not limited to, the keypad button, actuator, housing, and other parts of the button assembly, may have a class A surface for use in, for example, an interior of an automobile.

According to some embodiments, the button assembly includes an actuator assembly arranged in an interior space between a first and second housing member. The actuator assembly includes a first wing member, a second wing member, and a torsion member. The first wing member and the second wing member are separately pivoting components, with each of the first wing member and the second wing member coupled to the first housing member at or near respective opposing ends of the actuator assembly. The first wing member and the second wing member are also pivotably connected to the actuator. The torsion bar is fixed in a vertical position relative the second housing member. The torsion bar is an elongate member that extends between and connects to the first wing member to the second wing member, as will be further described herein. When the keypad button is pressed such as, for example, by a user pressing the button to activate some component in electrical connection with the electronic switch, the first wing member and the second wing member are configured to pivotably rotate about their respective pivot axis, thereby causing displacement of an other end of the respective first wing member and the second wing member opposite the respective pivot axis. The button assembly thereby translates downward actuator force applied onto the actuator to cause pivotable displacement of the actuator assembly to trigger electrical circuitry such as, for example, an electronic switch in response to the cover plate 110 being pressed.

By being pivotally connected to the housing and the actuator and the torsion element connecting the first wing member to the second wing member, the actuator assembly is configured to provide parallel movement of the first wing member and the second wing member even when the keypad button is pressed by a user outside the middle of a first axis (Y-axis). In addition, the torsion element includes sufficient stiffness and rigidity to enable parallel movement of the first wing member and the second wing member when the keypad button is pressed outside the middle of a second axis (X-axis).

The embodiments of the present disclosure overcome deficiencies of conventional button assemblies known in the prior art by providing button assemblies capable of compensating for off-center application of actuator force to the keypad button surface, thereby providing improved, consistent activation of the button's electronic switch. Rather than utilizing wing members that rotate about a common pivot axis to collapse downward to activate the electronic switch and include arms that overlap with the arms of other wing members, the embodiments described herein include separately pivotable wing members that pivotably rotate about separate respective pivot axis to enforce parallel displacement of the first wing member and the second wing member.

The embodiments of the present disclosure also overcome deficiencies in conventional keypad buttons due to tilt of the actuator assemblies. Tilt is caused by interior space limitations of the button assemblies relative to button size. The dimensions of button assemblies such as, for example, a length, width, and depth of button travel, play a significant role in the push button design. For example, a size of the button including the size of the button surface may be dependent on the available space in the location where the button is installed. As the ratio between the user-actuatable surface area of the button compared to vertical travel changes, e.g., the surface area increases relative to vertical button travel, a likelihood that off-center engagement of the keypad button fails to activate the electronic circuitry (e.g., electronic switch) increases. In this regard, the embodiments described herein are capable of compensating for tilt by providing the actuator assembly capable of parallel pivotal displacement of the first wing member and second wing member in response to pressing the keypad button.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

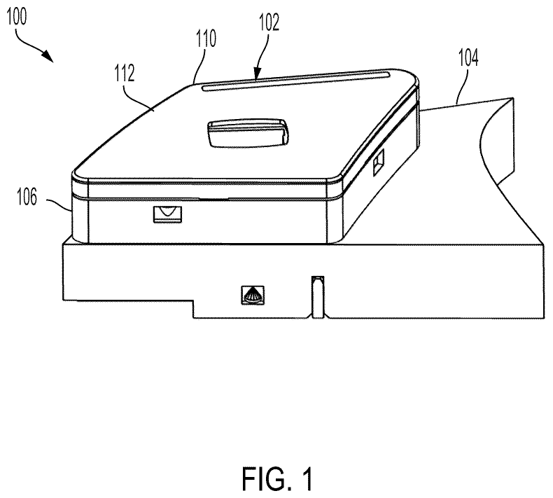

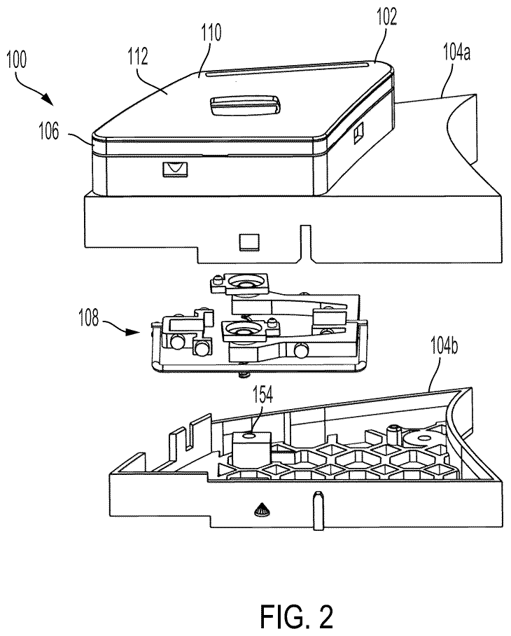

FIG. 1 is a perspective view illustrating a button assembly 100, according to some embodiments. FIG. 2 is a partial exploded view illustrating the button assembly 100 of FIG. 1, according to some embodiments. Unless specifically referenced, FIGS. 1 and 2 will be described collectively.

Button assembly 100 can include a keypad button 102 and a housing 104. The keypad button 102 may include an actuator 106 configured to engage one or more components of actuator assembly 108 (FIG. 2). The button assembly 100 and keypad button 102 includes a cover plate 110 arranged on a top surface of actuator 106 of keypad button 102. The cover plate 110 may have any of a plurality of different designs formed thereon to provide a visual indication to a user operating the keypad button 102 of the function(s) being activated when the keypad button 102 is pressed. The cover plate 110 may be attached to the actuator 106 of keypad button 102 by a fastener. For example, the cover plate 110 may be attached to the keypad button 102 using an adhesive, screw, clips, film, epoxy, other types of fasteners, or any combinations thereof.

It is to be appreciated by those having ordinary skill in the art that the one or more embodiments shown in the figures are exemplary and not intended to be limiting. It is also to be appreciated by those having ordinary skill in the art that a size and position of the cover plate 110 and actuator 106 relative to housing 104 may vary and is not intended to be limiting. As shown in FIG. 1, in some embodiments, the actuator 106 and cover plate 110 may include a size and shape such as to cover a portion of the top of housing 104 such as to be off-center relative to housing 104. In other embodiments, the cover plate 110 may completely cover the top of housing 104. The embodiments described herein provide an improvement over the prior art in that the button assembly 100 may be designed to include different sizes and shapes based on the intended application of the button assembly 100, but where off-center engagement of the cover plate 110 by the user pressing down on cover plate 110 and actuator 106 can consistently activate the electronic switch in response to being pressed. It is also to be appreciated by those having ordinary skill in the art that the button assembly 100 may include one or more of the components described herein or may include additional other components so long as the button assembly 100 is capable of operation in accordance with the present disclosure.

Referring to FIG. 2, the housing 104 may include a first housing member 104a and a second housing member 104b defining an interior region. The button assembly 100 includes actuator assembly 108 arranged in the interior region defined by the first housing 104a and second housing 104b. The actuator assembly 108 may include housing pivot pins to pivotably couple the actuator assembly 108 to the first housing 104a and actuator pivot pints to pivotably couple the actuator assembly 108 to the actuator 106, as will be further described herein. In this regard, in some embodiments, the housing 104a may also include one or more sidewalls that define a region configured to house the actuator 106 and the electronic circuitry.

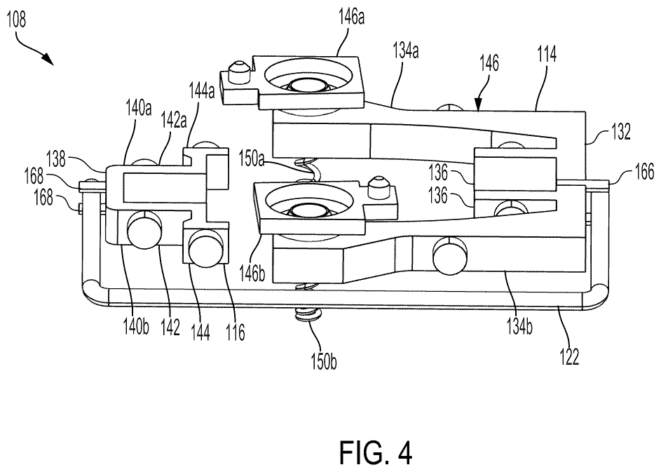

The button assembly 100 includes at least one spring element 150 (FIG. 4) that exerts a spring force between a bottom surface of second housing 104b and actuator assembly 108 sufficient to enable the actuator assembly 108 to maintain engagement with the elastomeric domes 146. When an actuator force is applied to the cover plate 110 to press down actuator 106, the actuator 106 is displaced downward relative to housing 104a. The actuator 106 is connected to the actuator assembly 108 at the actuator pivot pins and causes the pivotal displacement of the actuator assembly 108 to translate the actuator force to the elastomeric domes 146, thereby causing the actuator assembly 108 to activate the electronic circuitry.

According to various embodiments, instead of the elastomeric domes 146, the actuator assembly 108 may include any other kind of electrical switching element or haptic element or a combination of electrical switching element and haptic element. That is, it is to be appreciated by those having ordinary skill in the art that the actuator assembly 108 is not intended to be limited to including elastomeric domes 146 for engaging with the actuator assembly 108 and activating the electrical switch circuitry in response to the keypad button 102 being pressed.

According to various embodiments, the spring elements 150 may not be limited to compression springs and may be any other kind of spring element. In some embodiments, the first wing member 114 and the spring elements 150 may be integrally formed into one component. In some embodiments, the spring elements 150 may also act as a damper for providing noise reduction. In other embodiments, instead of or in addition to spring elements 150, the actuator assembly 108 may include a mechanical end stop configured to provide a more stable neutral position of the actuator.

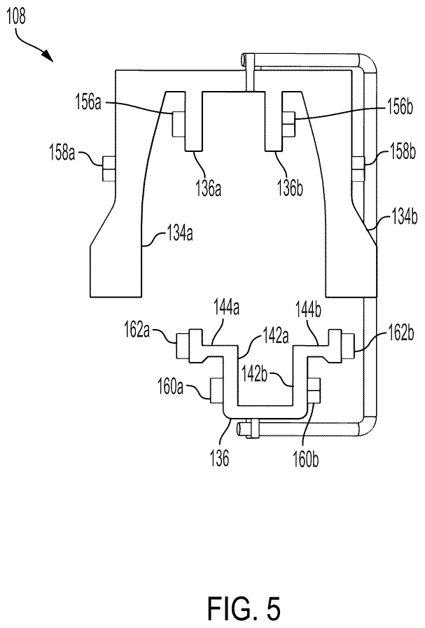

In some embodiments, the actuator 106 includes one or more slots and first housing 104a includes one or more corresponding tabs. In other embodiments, the actuator 106 includes one or more tabs and the first housing 104a includes one or more corresponding slots. The tabs are configured to be positioned in the slots so that the actuator 106 can move in a vertical direction relative to housing 104a in response to the actuator force or an opposing force exerted by the elastomeric domes 146. It is to be appreciated by those having ordinary skill in the art that the button assembly 100 may include any of a plurality of other features to enable the vertical displacement of the actuator 106 relative to the first housing 104a and is not intended to be limited to slots and tabs. For example, in some embodiments, the button assembly 100 may include slots, tabs, pins, channels, sidewalls, cutouts, tracks, guides, other like features, or any combinations thereof. For example, as shown in FIG. 5, the first housing 104a may also include a central channel and the actuator 106 may be disposed around the central channel.

Although not shown in the figures, it is to be appreciated by those having ordinary skill in the art that the button assembly 100 can include one or more other components in accordance with the present disclosure. In some embodiments, the button assembly 100 may also include foils, gaskets, printable circuit boards (PCBs), light emitting diodes (LEDs), fasteners, embossments, other like components, or any combinations thereof. For example, the button assembly 100 may include a PCB for controlling operation of one or more LEDs to illuminate the cover plate 110 based on a current setting of the button assembly 100. In this regard, the cover plate 110 may be designed to show one or more parameters 112. Each parameter 112 may have a corresponding LED associated with the respective parameter 112 on the cover plate 110, and where pressing the keypad button 102 causes one of the LEDs to illuminate to provide a visual indication of the corresponding setting of button assembly 100.

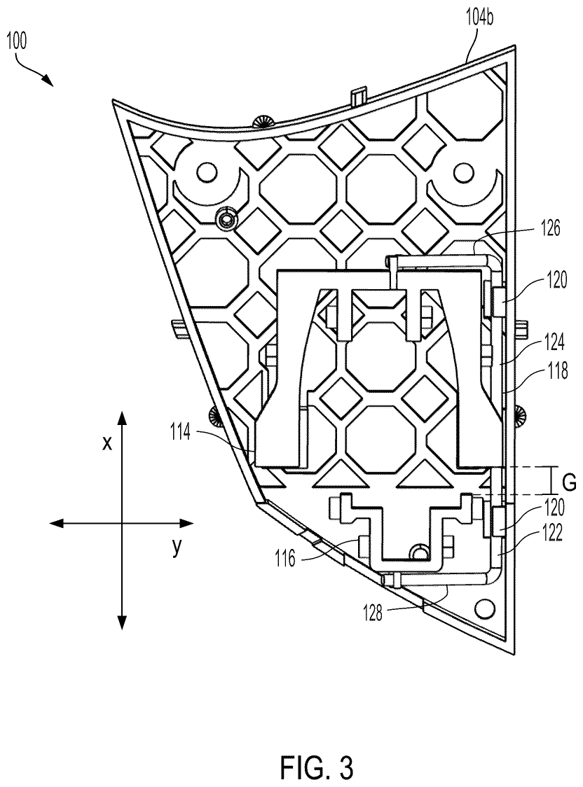

FIG. 3 illustrates a top view of a portion of the button assembly 100 of FIG. 1, according to some embodiments. Button assembly 100 includes an actuator assembly 108 arranged in a space defined between the keypad button 102 and the housing 104. The actuator assembly 108 includes first wing member 114 and second wing member 116.

Both first wing member 114 and second wing member 116 are generally u-shaped members including a generally planar top surface and a generally planar lower surface. According to some embodiments, the first wing member 114 is larger in size relative to second wing member 116. A width of the first wing member 114 and second wing member 116 is greater than a respective thickness of the first wing member 114 and the second wing member 116. The first wing member 114 includes a first y-axis extending portion and a plurality of first x-axis extending portions, and second wing member 116 includes a second y-axis extending portion, a pair of second x-axis extending portions extending therefrom, and a pair of third y-axis extending portions extending from the pair of second x-axis extending portions, as will be further described herein. It is to be appreciated by those having ordinary skill in the art that the specific size and dimensions of the first wing member 114 and second wing member 116 and their respective portions are exemplary and not intended to be limiting and may be tailored to the shape of the specific button.

Referring to FIG. 3, the first wing member 114 is shown as being larger in size relative the second wing member 116. In some embodiments, the first wing member 114 may be larger in size relative the second wing member 116. In other embodiments, the first wing member 114 may be smaller in size relative the second wing member 116. That is, the first wing member 114 may be different in size compared to second wing member 116. In some embodiments, the first wing member 114 and second wing member 116 may be similar in size. In other embodiments, the first wing member 114 and the second wing member 116 may be substantially similar in size.

The first wing member 114 is arranged relative the second wing member 116 so that there is no collision during displacement of the respective first wing member 114 and second wing member 116 in response to pressing the keypad button 102. Referring to FIG. 2, the first wing member 114 and the second wing member 116 are arranged along an x-axis relative to each other. The first wing member 114 and the second wing member 116 are arranged relative each other along the x-axis so that the first wing member 114 does not overlap a position of the second wing member 116 along the x-axis. That is, there may be a clear separation defined by a gap, G, along the x-axis between the first wing member 114 and the second wing member 116. The distance of the gap, G, may also be determined or selected based on an overall size of the button assembly 100 and the respective components of the actuator assembly 108 located therein. In some embodiments, the first wing member 114 and the second wing member 116 may include dimensions so that the second wing member 116 may be arranged relative the first wing member 114 so that the third arms 140 (FIG. 4) are positioned in between the first arms 134 (FIG. 4) of the first wing member 114 in the y-direction. In other embodiments, the first wing member 114 and the second wing member 116 may include dimensions so that the second wing member 116 may be arranged relative the first wing member 114 so that the third arms 140 (FIG. 4) are positioned outside the first arms 134 (FIG. 4) in the y-direction. In some embodiments, the first wing member 114 may be positioned relative the second wing member 116 so that there is no gap between the first wing member 114 and the second wing member 116.

The housing 104b includes a longitudinally extending channel 118 configured to receive a torsion element 122 to retain the torsion element 122 in a fixed vertical position relative to housing 104b. The channel 118 may extend in the x-axis direction. In some embodiments, the channel 118 may extend along a sidewall of housing 104b. In other embodiments, the channel 118 may extend along a bottom surface of housing 104b. In yet other embodiments, the channel 118 may be formed in the sidewall, the bottom surface, or both of housing 104 b. The housing 104 may also include one or more retention members 120 disposed along the channel 118. The retention members 120 are configured to retain torsion element 122 in channel 118 and in the vertically fixed position relative housing 104b while allowing the torsion element 122 to pivotably rotate along its longitudinal axis in channel 118 in response to pivotal displacement of the first wing member 114 or second wing member 116.

The actuator assembly 108 includes torsion element 122. The torsion element 122 includes an elongate segment 124, an end segment 126, and an end segment 128 opposite from end segment 126 on elongate segment 124. The elongate segment 124 extends in the x-axis direction between end segment 126 and end segment 128, and end segment 126 and end segment 128 extend in the y-axis direction and are coupled with first wing member 114 and second wing member 116, respectively, such that the torsion element 122 mechanically links the first wing member 114 with the second wing member 116. The length of elongate segment 124 may be dependent on the length and arrangement of the first wing member 114 and second wing member 116 relative to each other in the x-axis direction. In addition, the length of the end segment 126 and end segment 128 may be dependent on the length and arrangement of the first wing member 114 and the second wing member 116 relative to torsion element 122 in the y-axis direction and based on where the end segment 126 and end segment 128 connect to first wing member 114 and second wing member 116, respectively.

The torsion element 122 may be made of any of a plurality of different materials and the torsion element 122 may include any of a plurality of different designs configured to enforce parallel movement of the first wing member 114 and the second wing member 116. For example, the torsion element 122 may be made of stainless steel, copper, nickel, aluminum, iron, thermoplastics, other materials, or any combinations thereof. It is to be appreciated by those having ordinary skill in the art that the torsion element 122 is configured to provide robustness to the actuator assembly 108 in applications including large actuator assembly 108 and requiring large actuation forces to trigger the electronic circuitry.

The torsion element 122, including the elongate segment 124, end segment 126, and end segment 128, may possess a sufficient structural rigidity to substantially resist torsion applied onto torsion element 122 due to pivotal displacement of the first wing member 114 and second wing member 116 to thereby translate the pivotal displacement of one of the first wing member 114 or the second wing member 116 to the other of the first wing member 114 and the second wing member 116. When the keypad button 102 is pressed down, the actuator 106 travels downward and causes the pivotal displacement of one of the first wing member 114 or the second wing member 116, which engages the respective end segment 126 or end segment 128 and causes the torsion element 122 to pivotably rotate about the longitudinal axis of elongate segment 124 in channel 118. The torsion element 122 translates this rotational movement to the other of the end segment 126 and end segment 128 and engages the other of the first wing member 114 and the second wing member 116. In this regard, the torsion element 122 enforces parallel movement of the first wing member 114 and the second wing member 116 when the cover plate 110 of keypad button 102 is pressed outside a middle of the x-axis, y-axis, or the x-y-axis. In some embodiments, the torsion element 122 enforces parallel movement of the first wing member 114 and second wing member 116 when the cover plate 110 of keypad button 102 is pressed outside a middle of the y-axis so that the first wing member 114 and/or second wing member 116 pivots about one arm 134a, 140a or the other arm 134b, 140b.

The first wing member 114 includes first protruding portions 166 and second wing member 116 includes second protruding portions 168 configured to engage (e.g., retain) the respective end segment 126 and end segment 128 of the torsion element 122 such that the pivotal displacement of one of the first wing member 114 or the second wing member 116 causes parallel movement of the other of the first wing member 114 and the second wing member 116 through pivotal rotation of the elongate segment 124 of torsion element 122 relative to the second housing 104b, according to some embodiments. In other embodiments, the first wing member 114 and the second wing member 116 may each include a ball and socket joint configured to engage the respective end segment 126 and end segment 128 of the torsion element 122 such that the pivotal displacement of one of the first wing member 114 or the second wing member 116 is configured to cause parallel movement of the other of the first wing member 114 and the second wing member 116 through pivotal rotation of the torsion element 122 relative the second housing 104b. Although FIG. 3 shows the first wing member 114 includes the first protruding portions 166 and the second wing member 116 includes the second protruding portions 168, respectively. However, it is to be appreciated by those having ordinary skill in the art that the first wing member 114 and the second wing member 116 may be in connected engagement with the torsion element 122 using any of a plurality of connecting means such that the movement of the first wing member 114 and the second wing member 116 and the movement of the torsion element 122 do not collide, and do not influence the haptic feedback of the button assembly 100. That is, the first wing member 114 and the second wing member 116 are connected to the torsion element 122 so that the free play between the components is minimal.

FIG. 4 is a perspective view illustrating actuator assembly 108, according to some embodiments. The actuator assembly 108 includes the first wing member 114 and the second wing member 116. The first wing member 114 includes an elongate middle portion 132, a pair of first arms 134, and a pair of second arms 136. In some embodiments, the pair of first arms 134 includes first arm 134a and first arm 134b. The first arm 134a and first arm 134b extend from elongate middle portion 132. In some embodiments, the first arm 134a and first arm 134b may perpendicularly extend from respective opposite ends of elongate middle portion 132. In other embodiments, the first arm 134a may be substantially parallel with first arm 134b. In other embodiments, the first arm 134a and first arm 134b may extend from elongate middle portion 132 in a direction parallel to the x-axis shown in FIG. 3, and towards second wing member 116.

The pair of second arms 136 includes second arm 136a and second arm 136b. The second arm 136a and second arm 136b extend from elongate middle portion 132 between the pair of first arms 134. In some embodiments, the second arm 136a and second arm 136b may perpendicularly extend from respective intermediate segments ends of elongate middle portion 132. In some embodiments, the second arm 136a may be substantially parallel with second arm 136b. In other embodiments, the second arm 136a and second arm 136b may extend from elongate middle portion 132 in a direction parallel to the x-axis as shown in FIG. 3, and towards second wing member 116.

The second wing member 116 includes elongate middle portion 138 and a pair of third arms 140. In some embodiments, the pair of third arms 140 may include third arm 140a and third arm 140b. The third arm 140a and third arm 140b extend from elongate middle portion 138. In some embodiments, the third arm 140a and third arm 140b perpendicularly extend from the respective opposite ends of elongate middle portion 138 and towards the first wing member 114. In some embodiments, the third arm 140a may be substantially parallel with third arm 140b. In other embodiments, the third arm 140a and third arm 140b may extend from respective opposite ends of elongate middle portion 132 in a direction parallel to the x-axis shown in FIG. 3.

In addition, in some embodiments, the third arm 140a further includes first portion 142a and second portion 144a, and the third arm 140b further includes first portion 142b and second portion 144b. The first portion 142a and first portion 142b extends from the elongate middle portion 138. In some embodiments, the first portion 142a and first portion 142b may perpendicularly extend from the elongate middle portion 138. In other embodiments, the first portion 142a and first portion 142b may extend from respective opposite ends of elongate middle portion 138 towards second portion 144a and second portion 144b, respectively, and in a first direction. In some embodiments, the first direction may be parallel to the x-axis as shown in FIG. 3.

The second portion 144a and second portion 114b extend from the first portion 142a and first portion 142b in a second direction. In some embodiments, the second portion 144a and second portion 114b extend from respective opposite ends of elongate middle portion 138. In some embodiments, the second portion 144a and second portion 114b may perpendicularly extend from first portion 142a and first portion 142b. In other embodiments, the second portion 144a and second portion 114b perpendicularly extend from respective ends of first portion 142a and first portion 142b in a second direction. In some embodiments, as shown in FIG. 3, the second direction may be parallel to the y-axis.

The actuator assembly 108 may include elastomeric domes 146. In some embodiments, the elastomeric domes 146 may include elastomeric dome 146a and elastomeric dome 146b. The elastomeric domes 146 may be arranged on a top surface of first wing member 114 at an end of the pair of first arms 134. In some embodiments, the elastomeric dome 146a is arranged on the top surface of first wing member 114 at a distal end of first arm 134a and the elastomeric dome 146b is arranged on the top surface of first wing member 114 at a distal end of first arm 134b.

The elastomeric domes 146 are configured to engage the electronic circuitry and activate the electronic circuitry in response to the user pressing the cover plate 110 of keypad button 102. In some embodiments, the elastomeric domes 146 may also serve as spacers between the respective ends of the pair of first arms 134 of the first wing member 114 and the electronic circuitry, thereby enabling the keypad button 102, e.g., actuator 106, housing 104a, and cover plate 110, to be maintained in a raised position.

When an actuator force is applied to the cover plate 110, the actuator 106 causes the pivotal displacement of the actuator assembly 108 about its respective pivot axis and causes the elastomeric domes 146 to trigger the electronic circuitry. In some embodiments, the elastomeric domes 146 may be made of materials suitable for enabling the elastomeric domes 146 to withstand a certain number of cycles and to maintain the space between the first wing member 114 and the actuator 106. In addition, in some embodiments, the elastomeric domes 146 may be configured to substantially resist mechanical deformation while translating the spring force from spring elements 150. In some other embodiments, the elastomeric domes 146 may be configured such as to provide a desirable tactile response when the user presses on the keypad button 102 (e.g., cover plate 110), according to some embodiments. For example, the elastomeric domes 146 may be configured to compress, at least in part, in response to the pivotable displacement of the actuator assembly 108 causing the elastomeric domes 146 to activate the electronic circuitry. It is to be appreciated by those having ordinary skill in the art that the size, dimensions, and shape of the elastomeric domes 146 may be tailored based on the size of the button assembly 100. For example, a height of the elastomeric domes 146 may depend on the size of the button assembly 100, the vertical travel of the keypad button 102, or other factors. In some embodiments, pulling the actuator assembly 108 may cause the orientation of elastomeric domes 146 and spring elements 150 to change.

The actuator assembly 108 may also include spring elements 150. In some embodiments, the spring elements 150 may include spring element 150a and spring element 150b. The spring elements 150 may be disposed in respective receptacles 154 arranged in housing 104b (see FIG. 2), the spring elements 150 being configured to apply the spring force onto the end of the pair of first arms 134 of the first wing member 114 opposite the elastomeric domes 146 such that the first wing member 114 maintains engagement with the elastomeric domes 146. In some embodiments, the spring element 150a may be opposite elastomeric dome 146a on first arm 134a and the spring element 150b may be opposite elastomeric dome 146b on first arm 134b.

The elastomeric domes 146, in cooperation with the spring elements 150, may be configured to return the actuator assembly 108 and the actuator 106 of keypad button 102 to a normal position after being pressed. When the cover plate 110 is pressed down by the user, the actuator 106 translates downward relative to housing 104a and housing 104b. The first wing member 114 and second wing member 116 are connected to the actuator 106. In addition, the first wing member 114 and second wing member 116 are also connected to the housing 104a of housing 104. The actuator 106 moving downward thereby causes the pivotable displacement of the first wing member 114 and second wing member 116 about their respective pivot axis. The first wing member 114 being pivotably displaced may then cause the elastomeric domes 146 to engage or activate the electronic circuitry. In some embodiments, the elastomeric domes 146 may partially deform in response to the actuator assembly 108 translating the force from the user pressing the cover plate 110 of keypad button 102. For example, the elastomeric domes 146 may include a domed portion that compresses in response to the actuator assembly 108 translating the user pressing the keypad button 102.

In response to the force on keypad button 102 being removed, the elastomeric domes 146 may be configured to provide an opposing force onto the ends of the pair of first arms 134 opposite the elongate middle portion 132 that is greater than the spring force provided by spring elements 150, thereby causing an opposing pivotal displacement of the first wing member 114 and second wing member 116 to cause the actuator 106 and cover plate 110 of keypad button 102 to move upward relative to the housing 104.

In this regard, in some embodiments, the distal ends of the pair of first arms 134 of the first wing member 114 engage the elastomeric domes 146 to activate the electronic circuitry in response to the keypad button 102, e.g., cover plate 110 and actuator 106, being pressed down by the user and the elastomeric domes 146 causes the keypad button 102, e.g., actuator 106 and cover plate 110, to raise upward in response to the keypad button 102 no longer being pressed.

FIG. 5 is a top view illustrating actuator assembly 108, according to some embodiments. In actuator assembly 108, the first wing member 114 and the second wing member 116 includes a plurality of pivot pins arranged thereon to enable the pivotable rotation of the first wing member 114 and the second wing member 116 along their respective pivot axis so that the actuator assembly 108 can cause the elastomeric domes 146 to activate the electronic circuitry.

The first wing member 114 includes first pins 156. In some embodiments, the first pins 156 may also be referred to as actuator pivot pins. The first pins 156 may pivotably connect the first wing member 114 to the actuator 106. When the user presses down on button assembly 100, the downward movement of the actuator 106 causes the pivotable displacement of the actuator assembly 108 to activate the electronic circuitry. In this regard, the arrangement of the pins on each of the first wing member 114 and second wing member 116, and their respective connections to housing 104a or actuator 106 enforces the actuator assembly 108 is a mechanism for providing only parallel movement.

In some embodiments, the first pins 156 includes first pin 156a extending in the y-axis direction from second arm 136a and first pin 156b extending in the y-axis direction from second arm 136b. The first pins 156 pivotably couple the first wing member 114 to the actuator 106. In some embodiments, as shown in FIG. 5, the first pin 156a and first pin 156b are positioned on opposing sides of the respective second arm 136a and second arm 136b and extend in opposite direction away from the each other. In other embodiments, the first pin 156a and first pin 156b may be positioned on adjacent sides of the second arms 136 and extend towards each other.

The first wing member 114 also includes second pins 158. In some embodiments, the second pins 158 may also be referred to as housing pivot pins. The second pins 158 may pivotably connect the first wing member 114 to first housing 104a. When the user presses on the button assembly 100, the actuator 106 moves downward relative to first housing 104a (and second housing 104b) and causes the first wing member 114 to pivot about a pivot axis defined by the second pins 158.

In some embodiments, the second pins 158 includes second pin 158a extending in the y-axis direction from first arm 134a and second pin 158b extending in the y-axis direction from first arm 134b. In some embodiments, and as shown in FIG. 5, the second pin 158a and second pin 158b are positioned on opposing sides of the first arms 134 and extend in opposite direction away from the each other. In other embodiments, the second pin 158a and second pin 158b may be positioned on facing sides of the first arms 134 and extend towards each other.

The second wing member 116 includes third pins 160. In some embodiments, the third pins 160 may also be referred to as actuator pivot pins. The third pins 160 pivotably couple the second wing member 116 to actuator 106. In some embodiments, the third pins 160 includes third pin 160a and third pin 160b. When the user presses down on button assembly 100, the downward movement of the actuator 106 of keypad button 102 causes actuator 106 to move downward relative to first housing 104a. The actuator 106 is connected to third pins 160, which therefore causes the pivotable displacement of the second wing member 116 and the actuator assembly 108 activates the electronic circuitry.

In some embodiments, the third pins 160 includes third pin 160a extending in the y-axis direction from first portion 142a and third pin 160b extending in the y-axis direction from first portion 142b. In some embodiments, as shown in FIG. 5, the third pin 160a and third pin 160b are positioned on opposing sides of the respective first portion 142a and first portion 142b and extend in opposite direction away from the each other. In other embodiments, the third pin 160a and third pin 160b may be positioned on adjacent sides of the first portions 142 and extend towards each other.

The second wing member 116 also includes fourth pins 162. The fourth pins 162 may also be referred to as housing pivot pins. The fourth pins 162 pivotably couple the second wing member 116 to the first housing 104a. In some embodiments, the fourth pins 162 includes fourth pin 162a and fourth pin 162b. When the user presses on the button assembly 100, the housing 104a moves downward and causes the second wing member 116 to pivot about its pivot axis defined by the fourth pins 162.

In some embodiments, the fourth pins 162 includes fourth pin 162a extending in the y-axis direction from second portion 144a and fourth pin 162b extending in the y-axis direction from second portion 144b. In some embodiments, and as shown in FIG. 5, the fourth pin 162a and fourth pin 162b are positioned on oppositely facing sides of the respective second portion 144a and second portion 144b and extend in opposite direction away from the each other in the y-axis direction. In other embodiments, the fourth pin 162a and fourth pin 162b may be positioned on facing sides of the respective second portion 144a and second portion 144b and extend towards each other.

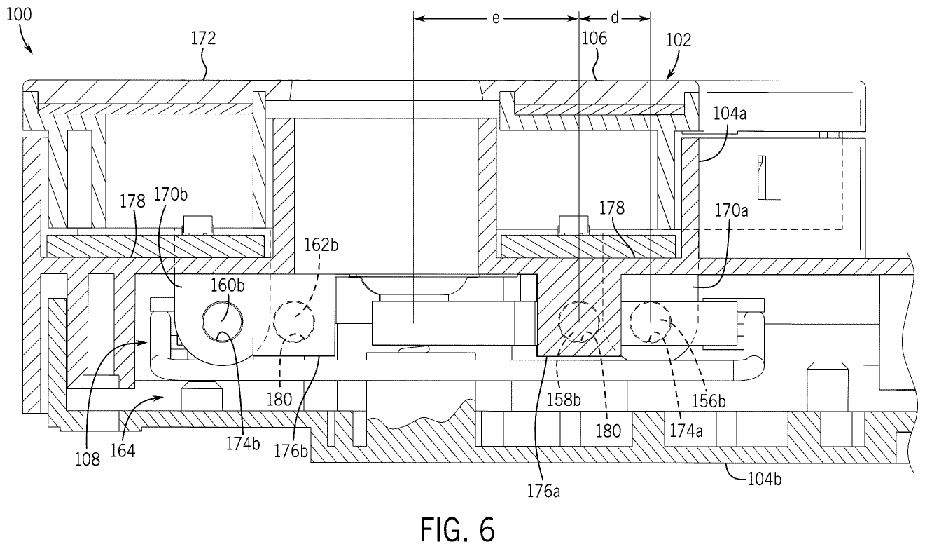

FIG. 6 is a partial sectional side view of the button assembly 100, according to some embodiments.

Button assembly 100 includes keypad button 102 and actuator assembly 108. The keypad button 102 includes first housing 104a, second housing 104b, and actuator 106. In some embodiments, the keypad button 102 may also include cover plate 110 disposed on a top surface of actuator 106. The keypad button 102 may also include electronic circuitry. The first housing 104a and second housing 104b define an interior region and the actuator assembly 108 is arranged in the interior region 164. In addition, the torsion element 122 may be pivotably coupled to the housing 104b at a respective channel formed in the housing 104b such as, for example, channel 118 as shown in FIG. 3 and retained in the fixed position relative the housing 104b by retention members such as, for example, retention members 120 as shown in FIG. 3.

The actuator 106 may be connected to actuator assembly 108 and configured to engage the actuator assembly 108 to cause the pivotal displacement of the actuator assembly 108 in response to the pressing of the actuator 106 (and cover plate 110) by a user. The actuator 106 includes retention members 170 extending from planar member 172 of actuator 106 and into the interior region 164. In some embodiments, the retention members 170 may include a pair of first retention members 170a and a pair of second retention members 170b. The retention members 170 may each include an aperture 174 located adjacent an end of the retention members 170 opposite the planar member 172. In some embodiments, the pair of first retention members 170a include apertures 174a and the pair of second retention member 170b includes aperture 174b. The pair of first retention members 170a are configured to receive the corresponding first pins 156a, 156b in the apertures 174a, and the pair of second retention members 170b are configured to receive the corresponding third pins 160a, 160b in the apertures 174b to pivotably couple the actuator 106 to the first wing member 114 and second wing member 116 of actuator assembly 108.

The number of retention members 170 extending from the actuator 106 may depend on the number of actuator pivot pins 156 arranged on first wing member 114 and the number of actuator pivot pins 160 arranged on second wing member 116. For example, the first wing member 114 may include two first pins 156 and second wing member 116 may include two third pins 160 and the actuator 106 may include four retention members 170 extending from a bottom of planar member 172.

The housing 104a may also be configured to connect to the actuator assembly 108. The housing 104a may include retention members 176 extending from a planar member 178 of housing 104a and towards the interior region 164. In some embodiments, the retention members 176 may include a first pair of retention members 176a and a second pair of retention members 176b. The retention members 176 may each include an aperture 180 located adjacent an end of the retention members 176 opposite the planar member 178. In some embodiments, the first pair of retention members 176a includes apertures 180a and the second pair of retention members 176b includes apertures 180b. The first pair of retention members 176a are configured to receive the second pins 158a, 158b in apertures 180 and the second pair of retention members 176b are configured to receive the fourth pins 162a, 162b in apertures 180 to pivotably couple the first housing 104a to the first wing member 114 and second wing member 116 of actuator assembly 108.

The number of retention members 176 extending from the first housing 104a may depend on the number of second pins 158 arranged on first wing member 114 and the number of fourth pins 162 arranged on second wing member 116. For example, the first wing member 114 may include a pair of second pins 158 and second wing member 116 may include a pair of fourth pins 162 and the first housing 104a may include four retention members 176 extending from a bottom of planar member 178 and connected to the pair of second pins 158 and the pair of fourth pins 162.

When the actuator 106 (and cover plate 110) moves downward in response to being pressed down by the user, the retention members 170 extending from actuator 106 also move downward and into interior region 164. As the retention members 170 is connected to the first wing member 114 and second wing member 116, the first wing member 114 and the second wing member 116 are pivotally displaced about their respective pivot axis defined by second pins 158 and fourth pins 162. The actuator 106 being connected to both of the first wing member 114 and the second wing member 116 ensures parallel movement when the actuator 106 is pressed outside the middle of the y-axis (see FIG. 3). In this regard, an off-center application of the downward actuating force onto the cover plate 110 or actuator 106 causes the parallel actuation of the actuator assembly 108, the pivotal displacement of the actuator assembly 108 thereby actuates the electrical circuitry in the button assembly 100.

On first wing member 114, the distance d between the pivot axis defined by second pins 158 and the first pins 156 may determine a final actuating force needed to fully press down on the actuator assembly 108. In addition, on first wing member 114, the distance e between the second pins 158 and a distal end of the first arm 134 at the elastomeric domes 146 and spring elements 150 may also have an impact on the actuation force needed to fully press down on the actuator assembly 108.

It is also to be appreciated by those having ordinary skill in the art that the pins/holes on the first wing member 114, the second wing member 116, or both first wing member 114 and second wing member 116 may be reversed. For example, in some embodiments, on first wing member 114, first pins 156b may be pivotably connected to housing 104a and second pins 158b may be pivotably connected to actuator 106 and, on second wing member 116, third pins 160b may be pivotably connected to housing 104a and fourth pins 162b may be pivotably connected to actuator 106.

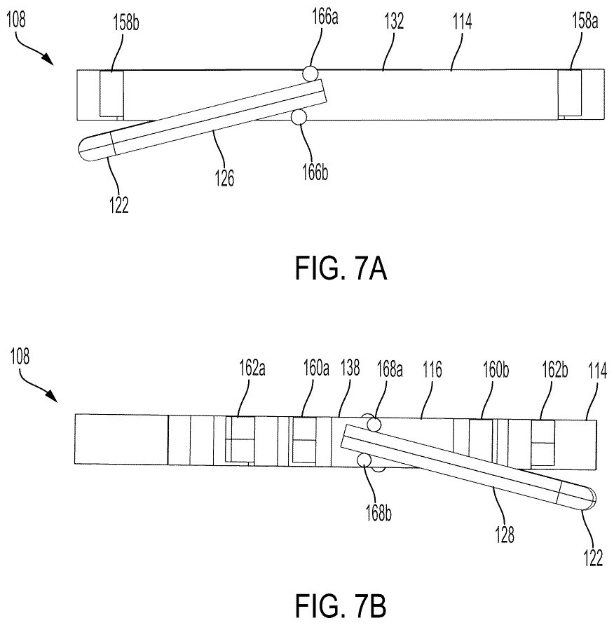

FIG. 7A is a first side view illustrating the actuator 106, according to some embodiments. FIG. 7B is a second side view illustrating the actuator 106, according to some embodiments. Unless specifically referenced, FIGS. 7A and 7B will be described collectively.

The first wing member 114 includes first protruding portions 166 and the second wing member 116 includes second protruding portions 168. In some embodiments, the first protruding portions 166 includes first protruding portions 166a and first protruding portions 166b, and the second protruding portions 168 includes second protruding portions 168a and second protruding portions 168b. The first protruding portions 166 of the first wing member 114 are configured to engage the end segment 126 of the torsion element 122 and the second protruding portions 168 of the second wing member 116 are configured to engage the end segment 128 of the torsion element 122 such that the pivotal displacement of one of the first wing member 114 or the second wing member 116 is configured to cause parallel movement of the other of the first wing member 114 and the second wing member 116 through pivotal rotation of the torsion element 122 relative the housing 104, according to some embodiments.

In some embodiments, the first wing member 114 and the second wing member 116 may each include a ball and socket joint configured to engage the respective end segment 126 and end segment 128 of torsion element 122 such that the pivotal displacement of one of the first wing member 114 or the second wing member 116 is configured to cause parallel movement of the other of the first wing member 114 and the second wing member 116 through pivotal rotation of the torsion element 122 relative the housing 104. It is to be appreciated by those having ordinary skill in the art that the torsion element 122 may be mechanically coupled to the first wing member 114 and second wing member 116 by any of a plurality of connecting means including the engagement of one or more protruding portions 182, ball and socket joints, other connecting means, or any combinations thereof, and is not intended to be limited to only one means of mechanically linking the actuator assembly 108 with the torsion element 122.

In some embodiments, a device includes a housing, an actuator, an actuator assembly including a first wing member, a second wing member, and a torsion element. In some embodiments, the first wing member and the second wing member are pivotably coupled to the housing and the actuator, In some embodiments, in response to an actuator force, the actuator causes a pivotable displacement of the first wing member and the second wing member about respective pivot axis to actuate an electrical switch.

In some embodiments, in response to the actuator force being outside of a first axis, the torsion element enforces parallel movement of the first wing member and the second wing member to actuate the electrical switch. In some embodiments, in response to the actuator force applied being outside of a second axis, the first wing member and the second wing member being pivotably coupled to the actuator and the housing enables parallel movement of the first wing member and the second wing member to actuate the electrical switch.

In some embodiments, the first wing member includes a first elongate middle portion, a pair of first arms, the pair of first arms extend from opposite ends of the first elongate middle portion, and the pair of first arms are connected to the actuator. In some embodiments, the first wing member includes a pair of second arms, the pair of second arms extend from the first elongate middle portion between the pair of first arms, the pair of second arms are connected to the housing.

In some embodiments, the first wing member further includes a pair of first pins, the pair of first pins are located on the pair of first arms, and the pair of first pins being pivotably connect to the actuator. In some embodiments, the first wing member further includes a pair of second pins, the pair of second pins are located on the pair of second arms, and the pair of second pins being pivotably connect to the housing.

In some embodiments, the second wing member further includes a second elongate middle portion, and a third pair of arms including a pair of first portions, the pair of first portions extend from respective ends of the second elongate middle portion, and the pair of first portions connects to the actuator. In some embodiments, the second wing member further includes a pair of second portions, the pair of second portions extend from respective ends of the pair of first portion opposite the second elongate middle portion, and the pair of second portions connects to the housing.

In some embodiments, the second wing member further includes a pair of third pins, the pair of third pins are located on the pair of first portions, the pair of third pins connect to the actuator. In some embodiments, the second wing member further includes a pair of fourth pins, the pair of fourth pins are located on the pair of second portions, the pair of fourth pins connect to the housing.

In some embodiments, the housing includes a first housing member, and a second housing member including a channel, the torsion element is pivotably arranged in the channel, and at least one retaining member, the at least one retaining member is configured to retain the torsion element in the channel.

In some embodiments, the device further including a pair of elastomeric domes, and a pair of spring elements, and the first wing member is disposed between the pair of elastomeric domes and the pair of spring elements.

In some embodiments, in response to the pivotable displacement of the actuator assembly, the first wing member causes the pair of elastomeric domes to activate the electrical switch.

In some embodiments, the first wing member does not overlap a position of the second wing member.

In some embodiments, an actuator assembly includes a first wing member, a second wing member, and a torsion element, the torsion element mechanically links the first wing member with the second wing member. In some embodiments, the first wing member does not overlap a position of the second wing member. In some embodiments, the first wing member and the second wing member being configured to connect an actuator and a housing. In some embodiments, in response to an actuator force, the actuator causes a pivotable displacement of the first wing member and the second wing member about respective pivot axis to actuate an electrical switch.

In some embodiments, in response to the actuator force being outside of a first axis, the torsion element enforces parallel movement of the first wing member and the second wing member to actuate the electrical switch.

In some embodiments, in response to the actuator force applied being outside of a second axis, the first wing member and the second wing member being pivotably coupled to the actuator and the housing enables parallel movement of the first wing member and the second wing member to actuate the electrical switch.

In some embodiments, the first wing member includes a first elongate middle portion, a pair of first arms, the pair of first arms extend from opposite ends of the first elongate middle portion, and the pair of first arms are connected to the actuator, and a pair of second arms, the pair of second arms extend from the first elongate middle portion between the pair of first arms, and the pair of second arms are connected to the housing.

In some embodiments, the first wing member further includes a pair of first pins, the pair of first pins are located on the pair of first arms, and the pair of first pins pivotably connect to the actuator, and a pair of second pins, the pair of second pins are located on the pair of second arms, and the pair of second pins pivotably connect to the housing.

In some embodiments, the second wing member further includes a second elongate middle portion, and a third pair of arms including a pair of first portions, the pair of first portions extend from respective ends of the second elongate middle portion, and the pair of first portions connects to the actuator, and a pair of second portions, the pair of second portions extend from respective ends of the pair of first portion opposite the second elongate middle portion, and the pair of second portions connects to the housing.

In some embodiments, the second wing member further includes a pair of third pins, the pair of third pins are located on the pair of first portions, and the pair of third pins connect to the actuator, and a pair of fourth pins, the pair of fourth pins are located on the pair of second portions, and the pair of fourth pins connect to the housing.

In some embodiments, a system includes a housing including a first housing member, and a second housing member, an actuator, an electronic switch, a pair of elastomeric domes, a pair of spring elements, and an actuator assembly including a first wing member including a pair of first pins coupled to the actuator, and a pair of second pins coupled to the second housing member, the first wing member is located between the pair of elastomeric domes and the pair of spring elements, a second wing member including a pair of third pins coupled to the actuator, and a pair of fourth pins coupled to the second housing member, and a torsion element, the torsion element is pivotably retained in a channel of the second housing member, the torsion element mechanically links the first wing member with the second wing member, the first wing member does not overlap a position of the second wing member, and, in response to an actuator force, the actuator causes a pivotable displacement of the first wing member and the second wing member about respective pivot axis to cause the pair of elastomeric domes to actuate an electrical switch.

In some embodiments, the first wing member further includes a first elongate middle portion, a pair of first arms including the pair of second pins, the pair of first arms extend from opposite ends of the first elongate middle portion, and a pair of second arms including the pair of first pins, the pair of second arms extend from the first elongate middle portion between the pair of first arms. In some embodiments, the second wing member further includes a second elongate middle portion, and a pair of third arms including a pair of first portions extending from a respective end of the second elongate middle portion and including the pair of third pins, and a pair of second portions extending from the respective end of the pair of first portions opposite the second elongate middle portion and including the pair of fourth pins.

In some embodiments, in response to the actuator force being outside of a first axis, the torsion element enforces parallel movement of the first wing member and the second wing member to actuate the electrical switch, and, in response to the actuator force applied being outside of a second axis, the first wing member and the second wing member being pivotably coupled to the actuator and the housing enables parallel movement of the first wing member and the second wing member to actuate the electrical switch.

This application relates to a device comprising a housing, an actuator, and an actuator assembly, according to claim 1.

This application also relates to an actuator assembly, comprising a first wing member, a second wing member and a torsion element, according to claim 15.

This application further relates to a system, having a first housing member, a second housing member, according to claim 24.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or any combination(s) thereof.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A device comprising:
a housing;
an actuator;
an actuator assembly comprising:
a first wing member,
a second wing member, and
a torsion element; and
wherein the first wing member and the second wing member are pivotably coupled to the housing and the actuator,
wherein, in response to an actuator force, the actuator causes a pivotable displacement of the first wing member and the second wing member about respective pivot axis to actuate an electrical switch.

2. The device of claim 1, wherein, in response to the actuator force being outside of a first axis, the torsion element enforces parallel movement of the first wing member and the second wing member to actuate the electrical switch;
wherein, in response to the actuator force applied being outside of a second axis, the first wing member and the second wing member being pivotably coupled to the actuator and the housing enables parallel movement of the first wing member and the second wing member to actuate the electrical switch.

3. The device of claim 1, wherein the first wing member comprises:
a first elongate middle portion,
a pair of first arms,
wherein the pair of first arms extend from opposite ends of the first elongate middle portion,
wherein the pair of first arms are connected to the actuator, and a pair of second arms,
wherein the pair of second arms extend from the first elongate middle portion between the pair of first arms,
wherein the pair of second arms are connected to the housing.

4. The device of claim 3, wherein the first wing member further comprises:
a pair of first pins,
wherein the pair of first pins are located on the pair of first arms,
wherein the pair of first pins pivotably connect to the actuator; and
a pair of second pins;
wherein the pair of second pins are located on the pair of second arms,
wherein the pair of second pins pivotably connect to the housing.

5. The device of claim 1, wherein the second wing member further comprises:
a second elongate middle portion, and
a third pair of arms comprising:
a pair of first portions,
wherein the pair of first portions extend from respective ends of the second elongate middle portion,
wherein the pair of first portions connects to the actuator, and
a pair of second portions,
wherein the pair of second portions extend from respective ends of the pair of first portion opposite the second elongate middle portion,
wherein the pair of second portions connects to the housing.

6. The device of claim 5, wherein the second wing member further comprises:
a pair of third pins,
wherein the pair of third pins are located on the pair of first portions,
wherein the pair of third pins connect to the actuator; and
a pair of fourth pins;
wherein the pair of fourth pins are located on the pair of second portions,
wherein the pair of fourth pins connect to the housing.

7. The device of claim 1, wherein the housing comprises:
a first housing member, and
a second housing member comprising:
a channel,
wherein the torsion element is pivotably arranged in the channel, and
at least one retaining member,
wherein the at least one retaining member is configured to retain the torsion element in the channel.

8. The device of claim 1, further comprising:
a pair of elastomeric domes, and
a pair of spring elements,
wherein the first wing member is disposed between the pair of elastomeric domes and the pair of spring elements.

9. The device of claim 8, wherein, in response to the pivotable displacement of the actuator assembly, the first wing member causes the pair of elastomeric domes to activate the electrical switch.

10. The device of claim 1, wherein the first wing member does not overlap a position of the second wing member.

11. An actuator assembly comprising:
a first wing member;
a second wing member; and
a torsion element;
wherein the torsion element mechanically links the first wing member with the second wing member;
wherein the first wing member does not overlap a position of the second wing member, the first wing member and the second wing member being configured to connect an actuator and a housing; and
wherein, in response to an actuator force, the actuator causes a pivotable displacement of the first wing member and the second wing member about respective pivot axis to actuate an electrical switch.

12. The actuator assembly of claim 11, wherein, in response to the actuator force being outside of a first axis, the torsion element enforces parallel movement of the first wing member and the second wing member to actuate the electrical switch.

13. The actuator assembly of claim 11, wherein, in response to the actuator force applied being outside of a second axis, the first wing member and the second wing member being pivotably coupled to the actuator and the housing enables parallel movement of the first wing member and the second wing member to actuate the electrical switch.

14. The actuator assembly of claim 11, wherein the first wing member comprises:
a first elongate middle portion,
a pair of first arms,
wherein the pair of first arms extend from opposite ends of the first elongate middle portion,
wherein the pair of first arms are connected to the actuator, and
a pair of second arms,
wherein the pair of second arms extend from the first elongate middle portion between the pair of first arms,
wherein the pair of second arms are connected to the housing.

15. The actuator assembly of claim 14, wherein the first wing member further comprises:
a pair of first pins,
wherein the pair of first pins are located on the pair of first arms,
wherein the pair of first pins pivotably connect to the actuator; and
a pair of second pins;
wherein the pair of second pins are located on the pair of second arms,
wherein the pair of second pins pivotably connect to the housing.

16. The actuator assembly of claim 11, wherein the second wing member further comprises:
a second elongate middle portion, and
a third pair of arms comprising:
a pair of first portions,
wherein the pair of first portions extend from respective ends of the second elongate middle portion,
wherein the pair of first portions connects to the actuator, and
a pair of second portions,
wherein the pair of second portions extend from respective ends of the pair of first portion opposite the second elongate middle portion,
wherein the pair of second portions connects to the housing.

17. The actuator assembly of claim 16, wherein the second wing member further comprises:
a pair of third pins,
wherein the pair of third pins are located on the pair of first portions,
wherein the pair of third pins connect to the actuator; and
a pair of fourth pins;
wherein the pair of fourth pins are located on the pair of second portions,
wherein the pair of fourth pins connect to the housing.

18. A system comprising:
a housing comprising:
a first housing member, and
a second housing member;
an actuator;
an electronic switch;
a pair of elastomeric domes;
a pair of spring elements;
an actuator assembly comprising:
a first wing member comprising:
a pair of first pins coupled to the actuator, and
a pair of second pins coupled to the second housing member,
wherein the first wing member is located between the pair of elastomeric domes and the pair of spring elements;
a second wing member comprising:
a pair of third pins coupled to the actuator, and
a pair of fourth pins coupled to the second housing member; and
a torsion element,
wherein the torsion element is pivotably retained in a channel of the second housing member,
wherein the torsion element mechanically links the first wing member with the second wing member;
wherein the first wing member does not overlap a position of the second wing member;
wherein, in response to an actuator force, the actuator causes a pivotable displacement of the first wing member and the second wing member about respective pivot axis to cause the pair of elastomeric domes to actuate an electrical switch.

19. The system of claim 18, wherein the first wing member further comprises:
a first elongate middle portion,
a pair of first arms comprising:
the pair of second pins,
wherein the pair of first arms extend from opposite ends of the first elongate middle portion, and
a pair of second arms comprising:
the pair of first pins,
wherein the pair of second arms extend from the first elongate middle portion between the pair of first arms;
wherein the second wing member further comprises:
a second elongate middle portion, and
a pair of third arms comprising:
a pair of first portions extending from a respective end of the second elongate middle portion and comprising the pair of third pins, and
a pair of second portions extending from the respective end of the pair of first portions opposite the second elongate middle portion and comprising the pair of fourth pins.

20. The system of claim 18, wherein, in response to the actuator force being outside of a first axis, the torsion element enforces parallel movement of the first wing member and the second wing member to actuate the electrical switch; and
wherein, in response to the actuator force applied being outside of a second axis, the first wing member and the second wing member being pivotably coupled to the actuator and the housing enables parallel movement of the first wing member and the second wing member to actuate the electrical switch.
